(19) United States
(12) Patent Application Publication
(10) Pub. No.: US 2024/0391273 A1
(43) Pub. Date: Nov. 28, 2024

(54) HUB ASSEMBLY FOR A HUB FOR A BICYCLE WHEEL, COMPENSATING ELEMENT FOR SAME, HUB, AND BICYCLE WHEEL

(71) Applicant: Jenny Und Frank Sportartikelhandel GbR, Murr (DE)

(72) Inventor: Christian Jenny, Backnang (DE)

(21) Appl. No.: 18/696,654

(22) PCT Filed: Sep. 29, 2022
(86) PCT No.: PCT/DE2022/100728

§ 371 Date: Jul. 2, 2024

(30) Foreign Application Priority Data
Sep. 30, 2021 (DE) 20 2021 105 300.3

(51) Int. Cl. B60B 27/02; B60B 27/00

(52) U.S. Cl. CPC B60B 27/023; B60B 27/001; B60B 27/0078

(57) ABSTRACT

In an embodiment a hub assembly includes an axle and a hub body, wherein the axle extends through the hub body in a longitudinal direction, wherein the hub body is rotatably supported relative to the axle via at least one rolling bearing, an end body fixed to or on the axle on a side of the rolling bearing facing away from the hub body, wherein a bearing section of the end body facing the rolling bearing as seen in the longitudinal direction is arranged on the inner ring of the rolling bearing and a compensating element arranged between the bearing section of the end body and the inner ring of the rolling bearing and/or between the bearing section of the hub body and the outer ring of the rolling bearing, wherein the compensating element has a variable extension when viewed in the longitudinal direction.

### CROSS-REFERENCE TO RELATED APPLICATIONS

This patent application is a national phase filing under section 371 of PCT/DE2022/100728, filed Sep. 29, 2022, which claims the priority of German utility model application 20 2021 105 300.3, filed Sep. 30, 2021, each of which is incorporated herein by reference in its entirety.

### TECHNICAL FIELD

The invention relates to a hub assembly for a hub of a bicycle wheel, to a hub for a bicycle wheel and a bicycle wheel.

### BACKGROUND

EP 2 559 569 A2 shows in FIGS. 3 and 6 a hub assembly and a hub (rear wheel hub) for a bicycle wheel. In the direction of the inner side, the axle of the hub assembly comprises a shoulder, upon which the inner ring of the rolling bearing abuts. This prevents the inner ring from moving on the axle in the direction of the inside of the hub assembly. Such an assembly can therefore be described as having low play or being free of play. As a result, the position of the brake disk and cogset in relation to the respective counterparts brake pad and derailleur only changes slightly with a compression of the axle, which favors precise shifting and friction-free braking. However, the rolling bearings are more likely to be strained when the wheel is installed, which can lead to increased friction and wear.

DE 20 2019 100 964 U1 shows a hub assembly of the type mentioned introductorily above as well as a hub (front wheel hub) with such a hub assembly. Here, no inner shoulders are provided on the axle, so that the axle-depending on the axial force being present—can move relative to the inner ring of the rolling bearing, or the inner ring can move on the axle, respectively. Such an assembly can therefore be described as having play. This assembly exhibits the advantage that a smooth-running rolling bearing and thus a smooth running of the bicycle wheel can always be achieved due to a more difficult or even prevented tensioning of the rolling bearing when the axle is compressed. The rolling bearing is therefore also subject to reduced wear. However, due to the play in the hub assembly and a possible back and forth movement of the axle in relation to the hub body, the possible occurrence of vibrations, a deteriorated shifting function and rubbing disk brakes could prove to be critical. This is because the position of the brake disk and cogset in relation to the respective brake pad and rear derailleur counterparts could change noticeably depending on the amount of play remaining after the axle is compressed.

### SUMMARY

Embodiments of the invention achieve smooth and low-wear operation with simultaneously reduced play and a reduced tendency to vibrate in the aforementioned hubs for bicycle wheels.

Embodiments of the invention provide a hub assembly comprising: a) an axle and a hub body, wherein the axle extends through the hub body in a longitudinal direction, wherein the hub body is rotatably supported relative to the axle via at least one rolling bearing, and wherein an inner ring of the rolling bearing is arranged on the axle, and an outer ring of the rolling bearing is arranged on or in the hub body, wherein a bearing section of the hub body facing the rolling bearing as viewed in the longitudinal direction is arranged on the outer ring of the rolling bearing, and b) an end body which is fixed to or on the axle on the side of the rolling bearing facing away from the hub body, wherein a bearing section of the end body facing the rolling bearing as seen in the longitudinal direction is arranged on the inner ring of the rolling bearing.

Quick-release skewers and thru axles are the means of choice for the reversible fixing of bicycle wheels in the fork (front wheel) or frame (rear wheel) of a bicycle. The importance of thru axles has increased significantly in recent years. Thru axles are now considered as a standard, in particular for mountain bikes and cross bikes.

When the quick-release or thru axle is tightened, which is necessary to secure the bicycle wheel, considerable axial forces are introduced into the hub assembly or the hub of the bicycle wheel, which can easily amount to several thousand newtons. Due to the associated compression of the axle of the bicycle wheel, the axle can thus lose length compared to the assembly of the hub body and end bodies, which can lead to a tensioning of the rolling bearings, and thus to increased friction and wear of said rolling bearings.

This effect can be taken into account by the hub assembly comprising a gap between the end body and the inner ring of the rolling bearing in uninstalled condition, which should then be reduced to the desired dimension or disappear completely in installed, i.e. braced condition.

However, as every user usually tensions the quick release or thru axle with a different or not exactly defined force, this goal is often only theoretically achievable in everyday use. Therefore, the manufacturer generally has to set more play than is probably necessary in order to avoid damaging of the bearing if the thru axle is tightened too much. However, this leaves too much play in the hub assembly for the majority of applications in normal operation. If the thru axle has a tool engagement for tightening, an exact torque wrench is often not available, especially not when removing and installing a wheel during a ride.

Accordingly, the hub assembly is further designed such that a compensating element is arranged between the bearing section of the end body and the inner ring of the rolling bearing and/or between the bearing section of the hub body and the outer ring of the rolling bearing, said compensating element having a variable extension when viewed in the longitudinal direction.

Further, a compensating element for a hub assembly contributes to solving the above-mentioned problems.

Further, a hub for a bicycle wheel, which comprises a hub, contributes to solving the aforementioned problems.

Finally, a bicycle wheel, which comprises a hub, also contributes to solving the aforementioned problems.

Embodiments of the invention can first of all prevent or significantly reduce detrimental stress on the rolling bearing due to the compression of the axle when the bicycle wheel is installed.

On the other hand, if play is present, a back-and-forth movement of the axle relative to the rolling bearing and the hub body can be prevented, as the compensating element can mitigate and absorb such a tendency to move.

In this way, the advantages of smooth-running rolling bearings and smoother operation when employing bearings with play can be realized without their disadvantages.

In addition, the compensating element can improve shifting and braking performance because the position of the brake disk and the cogset no longer changes as much as in a hub assembly with play. This minimizes the occurrence of shifting errors and rubbing brake disks.

The compensating element also has a vibration-damping effect and minimizes vibrations, which is very beneficial when braking, shifting gears and with regard to wheel grip.

The change in width of a gap, usually between the end body and the inner ring of the rolling bearing, due to compression of the axle by the quick release or the thru axle, can be compensated for by the compensating element. This prevents bracing or even destruction of the rolling bearing, at the same time without the axle being able to move back and forth unhindered due to the presence of a gap.

In the present case, the inner side is understood to be the side facing the inside of the hub assembly when viewed in the longitudinal direction (axial direction). The outer side is understood to be the side facing the outside of the hub assembly when viewed in the longitudinal direction. The inner ring of the rolling bearing, on the other hand, is—as usual—always the ring out of the two bearing rings of the rolling bearing with the smaller diameter. The outer ring of the rolling bearing is always the ring of the rolling bearing with the larger diameter.

In terms of the invention, a hub body is understood to be a body which is supported rotatably relative to the axle of the hub assembly via at least one rolling bearing, and through which the axle extends in a longitudinal direction. On the one hand, this relates to a body conventionally referred to as a hub body, to which the spokes of the wheel are attached. However, in terms of the invention, an optional body more conventionally referred to as a freewheel body is also understood to be a hub body. In this respect, the hub body with which the spokes are associated may be referred to as a first hub body, while an optional freewheel body may be referred to as a second hub body. A freewheel body is usually associated with a hub assembly or a hub for a rear bicycle wheel and serves to accommodate a power transmission means, in particular a cogset. A first and a second hub body are arranged next to each other when viewed in the longitudinal direction of the axle. Furthermore, the rotation of the second hub body (freewheel body) can be decoupled from the rotation of the first hub body. A first hub body is usually rotatably supported relative to the axle via two spaced-apart rolling bearings, and an optional second hub body (freewheel body) is usually rotatably supported relative to the axle via two further spaced-apart rolling bearings. Without deviating from the present inventive concept, it is possible to provide, as an alternative or in addition to a compensating element which is assigned to a rolling bearing of such a first hub body, a compensating element which is assigned to a rolling bearing of such a second hub body (freewheel body).

In terms of the invention, a rolling bearing is understood to be a bearing which is suitable for rotatably supporting a hub body relative to the axis of a hub assembly here in question, and which has an inner ring and an outer ring. Therefore, in addition to conventional rolling bearings with rolling elements, the term rolling bearing presently also includes plain bearings, and in particular joint bearings, which correspond to this definition, even if such bearings will usually not be referred to as rolling bearings.

In the following, the aspects according to the invention are discussed further, for which purpose reference is made in part to non-limiting advantageous embodiments and further developments of the invention. The features of advantageous further developments can be realized individually or in any combination, whereby further advantageous embodiments of the invention are provided.

In a first advantageous embodiment of the hub assembly, the axle is hollow. In particular, this makes it possible to provide an axle suitable for accommodating a quick release or a thru axle.

Preferably, the axle is designed as a hollow cylinder. In particular, an axle intended for a thru axle can be provided as a simple hollow cylinder, which simplifies manufacture.

Preferably, the axle and the end body are configured to accommodate a thru axle or a quick release.

Preferably, the axle does not comprise a shoulder on the inside of the inner ring of the rolling bearing. This allows the axle to be displaced relative to the inner ring in both longitudinal directions, which can prevent unwanted bracing of the rolling bearing if the axle is compressed during installation of the bicycle wheel, or prevent bracing during operation.

Preferably, the bearing section of the hub body and the hub body are manufactured in one piece. The bearing section can be manufactured integrally as a shoulder of the hub body, and can in particular be turned or milled.

Alternatively, the bearing section of the hub body could be formed by a sleeve inserted into the hub body, or be formed by a ring, in particular a retaining ring.

Preferably, the bearing section of the hub body is arranged on the inner side of the outer ring of the rolling bearing.

The bearing section of the hub body may correspond to an end of the hub body, related to the longitudinal direction.

Particularly preferred, the inner ring of the rolling bearing has a sliding fit relative to the axle, in particular wherein the inner ring can be displaced on the axle by hand or with light blows with a rubber mallet, and in particular in accordance with one of the fits H7/g6, H7/h6, H7/j6, or H7/m6 according to DIN 7154, DIN 7157.

In this respect, the inner ring can be designed in such a way that it is displaceable on the axle due to the effect of a force acting in the longitudinal direction.

Alternatively or additionally, the inner ring can be displaceable on the axle due to the change in length of the axle.

Particularly preferred, the end body is designed as an end cap for the axle. The end cap can thus cover the end face as well as the surface of one end of the axle.

Preferably, the end cap has an undersize relative to the axle, so that it can be pushed or pressed onto the axle. In relation to the hub assembly, the end cap is thus preferably pushed or pressed onto the axle.

In a particularly advantageous manner, the bearing section of the end body is arranged on the outside of the inner ring of the rolling bearing.

Alternatively, the bearing section of the end body could be an intermediate piece, e.g. a bushing, via which the end body is indirectly arranged on the outside of the inner ring.

In a further advantageous embodiment, the bearing section of the end body corresponds to an end of the end body related to the longitudinal direction.

Particularly preferred, a gap is present between the bearing section of the end body and the inner ring of the rolling bearing.

Alternatively or additionally, there may be a gap between the bearing section of the hub body and the outer ring of the rolling bearing.

The width of such a gap is preferably between 0.05 and 0.25 mm, and more preferably between 0.1 and 0.2 mm.

It is particularly preferred that the compensating element abuts directly on the inner ring of the rolling bearing.

Alternatively or additionally, a compensating element could abut directly on the outer ring of the rolling bearing.

In a particularly advantageous further development, the compensating element is arranged in such a way that it can absorb or compensate for the change in a gap width between the bearing section of the end body and the inner ring.

Alternatively or additionally, a compensating element could be arranged in such a way that it can absorb or compensate for the change in a gap width between the bearing section of the hub body and the outer ring.

The change in such a gap width could be brought about by a change in the length of the axle.

In a particularly advantageous manner, the compensating element can have resilient properties in relation to the longitudinal direction. This means that the compensating element can always compensate for a changing gap width.

Preferably, the compensating element can also have damping properties.

The compensating element is preferably made of plastic, of rubber material, of metal, in particular of steel, or made of a mixture or a composite of at least two of these.

Preferably, the compensating element comprises a steel spring, a wave washer or a leaf spring. Such a compensating element is particularly robust and durable.

In a further advantageous embodiment of the hub assembly, a plurality of compensating elements are arranged along the circumference of the inner ring or the outer ring of the rolling bearing.

Particularly preferred, an annular compensating element is arranged along the circumference of the inner ring or along the circumference of the outer ring of the rolling bearing.

Preferably, the compensating element is an O-ring.

It is advantageous if a compensating element abuts annularly on the axle and/or if a compensating element abuts annularly on the hub body.

With regard to an annular compensating element, it is further preferred that the cross-section of the compensating element as seen perpendicularly to its circumference is round, oval or angular.

In an advantageous embodiment of the hub according to the invention, the hub comprises a total of two or four rolling bearings. Two opposing rolling bearings are usually found in a front wheel hub, while a rear wheel hub usually comprises a total of four rolling bearings due to the additional mounting of a freewheel.

In this respect, the hub can also comprise a freewheel.

### BRIEF DESCRIPTION OF THE DRAWINGS

Supplementary or in addition to the advantageous embodiments and further developments of the teaching already discussed, embodiments of objects according to the invention shown in the drawings to the extent of FIGS. 1 to 3 are explained in more detail below. However, the examples discussed with reference to the drawings do not limit the invention to the examples shown. In discussing the embodiments with reference to the drawings, generally preferred embodiments and further developments of the teaching are also shown.

Further developments of the advantageous embodiments described above with features of the embodiments described below, just like further developments of the embodiments described below with features of the embodiments described above, expressly form further advantageous embodiments of the invention, and thus form part of the present disclosure.

With regard to the following explanation of the figures, it should generally be pointed out that reference signs already shown in previous figures and already explained above in this respect have in part not been reapplied in subsequent figures for reasons of clarity, and/or are in part not explained again on the basis of these subsequent figures. For the explanation of such reference signs and the associated technical features, reference is made in full to the respective description of the corresponding preceding figures in order to avoid repetition.

FIG. 1 shows a lateral sectional view of a preferred embodiment of the hub assembly according to the invention and of a hub according to the invention;

FIG. 2 shows a magnified representation of section Y from FIG. 1; and

FIG. 3 shows a magnified representation of section Z from FIG. 2.

### DETAILED DESCRIPTION OF ILLUSTRATIVE EMBODIMENTS

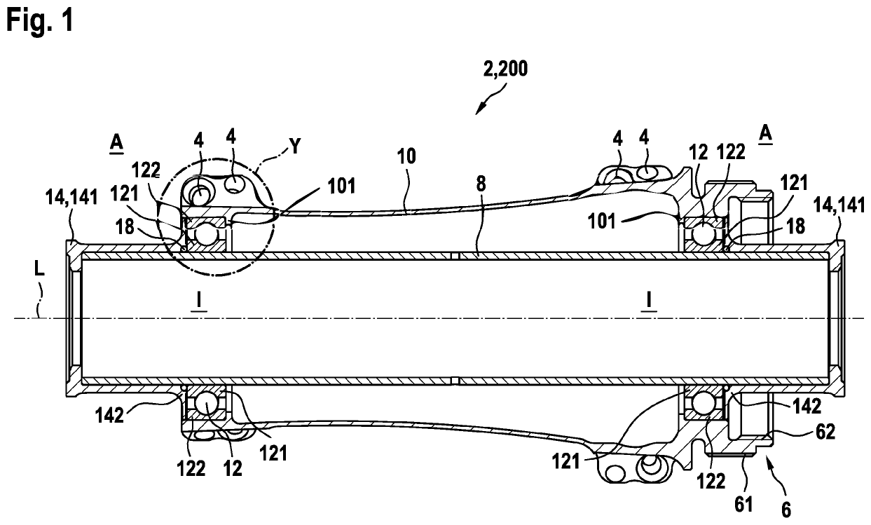

FIG. 1 shows a lateral sectional view of a preferred embodiment of the hub assembly 2 according to the invention and of a hub 200 according to the invention.

Specifically shown here are a hub assembly 2 and a hub 200 for the front wheel of a racing bike. The hub assembly 2 is designed to accommodate a thru axle (not shown) with the dimensions 100×12 mm.

The hub assembly 2 further comprises a total of 24 spoke holes 4 to accommodate so-called straight-pull spokes (not shown).

The hub assembly 2 is shown facing against the direction of travel. Therefore, a brake disk mount 6 according to the centerlock standard can here be seen on the right side. The brake disk mount 6 comprises an external multi-tooth profile 61 and an internal thread 62 for the retaining ring (not shown).

The hub assembly 2 for the hub 200 further comprises an axle 8 and a hub body 10, wherein the axle 8 extends through the hub body 10 in a longitudinal direction L.

The axle 8 is hollow here, namely designed as a simple hollow cylinder. This is possible in particular within a design to accommodate a thru axle.

The hub body 10 is supported for rotation relative to the axle 8 by two opposing rolling bearings 12. An inner ring 121 of each rolling bearing 12 is arranged on the axle 8, and an outer ring 122 of each rolling bearing 12 is arranged in the hub body 10.

In this case, a bearing section 101 of the hub body 10 facing the respective rolling bearing 12 as viewed in the longitudinal direction L is arranged on the outer ring 122 of the rolling bearing 12.

The bearing section 101 of the hub body 10 and the hub body 10 are manufactured in one piece, with the bearing section 101 corresponding to a circular shoulder or stop in the hub body 10.

Furthermore, the bearing section 101 of the hub body 10 is arranged on the inner side I of the outer ring 122 of the rolling bearing 12.

There is an end body 14 at each of the two longitudinal ends of the axle 8, which is fixed to the axle 8 on the side of the respective rolling bearing 12 which is facing away from the hub body 10.

The end bodies 14 are presently designed as end caps 141 for the axle 8. The end caps 141 have corresponding passages at the ends and are thus also configured, like the axle 8, to accommodate a thru axle.

One end cap 141 has an undersize relative to the axle 8, so that the end caps 141 are pushed or pressed onto the axle 8.

In this case, a bearing section 142 of the end body 14, namely of the end cap 141, which faces the rolling bearing 12 as viewed in the longitudinal direction L, is arranged on the inner ring 121 of the rolling bearing 12.

Furthermore, the bearing section 142 of the end body 14 is arranged on the outer side A of the inner ring 121 of the rolling bearing 12.

The bearing section 142 of the end body 14 also corresponds to an end of the end body 14 related to the longitudinal direction L, or as seen in the longitudinal direction L.

A gap 16 with a gap width 161 (see FIG. 3) of preferably approx. 0.1-0.2 mm exists between the bearing section 142 of the end body 14 and the inner ring 121.

The axle 8 comprises no shoulder on the inside I of the inner ring 121 of the rolling bearing 12. The inner ring 121 is displaceable on the axle 8 due to the effect of a force acting in the longitudinal direction L.

In particular, the inner ring 121 is displaceable on the axle 8 due to the change in the length of the axle 8.

Due to a compression or a relieving of the axle 8 in the longitudinal direction L, the gap 16 may become smaller or disappear completely, or on the other hand may be enlarged. This can lead to the disadvantages already described.

Therefore, here a compensating element 18 is arranged between the bearing section 142 of the end body 14 and the inner ring 121 of the rolling bearing 12, which has a variable extension when viewed in the longitudinal direction L.

The compensating element 18 is arranged in such a way that it can absorb or compensate for the change in a gap width 161 (see FIG. 3) between the bearing section 142 of the end body 14 and the inner ring 121.

The compensating element 18 is in direct contact with both the inner ring 121 and the bearing section 142.

In this case, the compensating element 18 comprises resilient properties in relation to the longitudinal direction L. The material also has damping properties.

Here, the compensating element 18 is an O-ring made of flexible plastic material. A sealing ring made of suitable material can be used for this purpose, for example.

The compensating element 18 is in annular contact with the axle 8 and along the circumference of both the inner ring 121 and the bearing section 142.

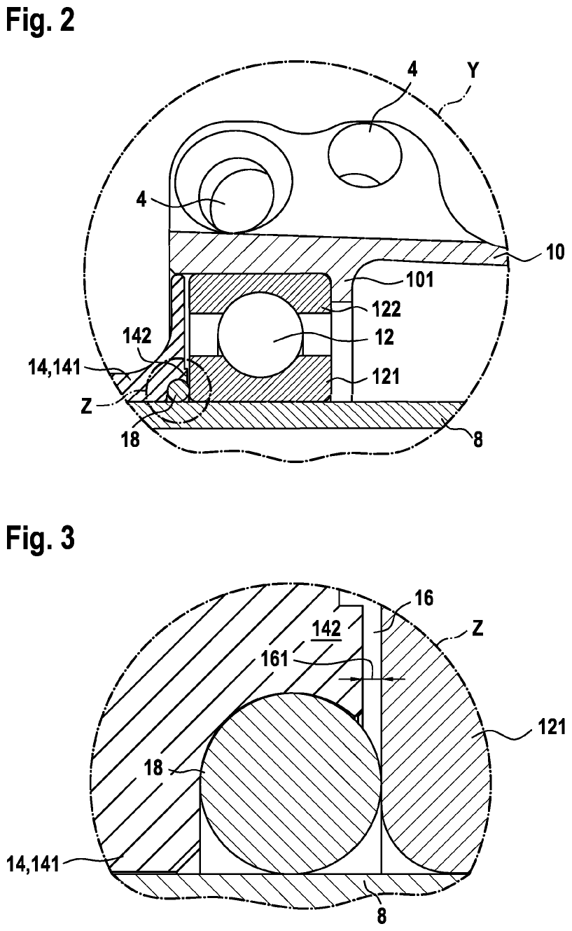

FIG. 2 shows a magnified representation of the section Y from FIG. 1, where the position of the compensating element 18 between the bearing section 142 of the end body 14, the axle 8 and the inner ring 121 of the rolling bearing 12 can be clearly seen. The compensating element 18 contacts both the bearing section 142 and the inner ring 121 and can thus absorb, cushion and dampen changes in the width 161 of the gap 16 (see FIG. 3).

FIG. 3 shows a magnified representation of the section Z from FIG. 2. The gap 16 with the gap width 161 between the bearing section 142 and the inner ring 121 is clearly visible here.

1.-34. (canceled)

35. A hub assembly for a hub of a bicycle wheel, the hub assembly comprising:
an axle;
a hub body,
wherein the axle extends through the hub body in a longitudinal direction,
wherein the hub body is rotatably supported relative to the axle via at least one rolling bearing,
wherein an inner ring of the rolling bearing is arranged on the axle and an outer ring of the rolling bearing is arranged on or in the hub body, and
wherein a bearing section of the hub body facing the rolling bearing as viewed in the longitudinal direction is arranged on the outer ring of the rolling bearing;
an end body fixed to or on the axle on a side of the rolling bearing facing away from the hub body,
wherein a bearing section of the end body facing the rolling bearing as seen in the longitudinal direction is arranged on the inner ring of the rolling bearing; and
a compensating element arranged between the bearing section of the end body and the inner ring of the rolling bearing and/or between the bearing section of the hub body and the outer ring of the rolling bearing,
wherein the compensating element has a variable extension when viewed in the longitudinal direction.

36. The hub assembly according to claim 35,
wherein the axle is hollow, and/or
wherein the axle is a hollow cylinder.

37. The hub assembly according to claim 35, wherein the axle and the end body are configured to receive a thru axle or a quick-release.

38. The hub assembly according to claim 35, wherein the axle comprises no shoulder on an inner side of the inner ring of the rolling bearing.

39. The hub assembly according to claim 35,
wherein the bearing section of the hub body and the hub body are one piece, and/or
wherein the bearing section of the hub body is arranged on an inner side of the outer ring of the rolling bearing, and/or
wherein the bearing section of the hub body corresponds to an end of the hub body related to the longitudinal direction.

40. The hub assembly according to claim 35, wherein the inner ring of the rolling bearing has a sliding fit relative to the axle.

41. The hub assembly according to claim 35,
wherein the inner ring of the rolling bearing is displaceable on the axle due to a force acting in the longitudinal direction, and/or
wherein the inner ring of the rolling bearing is displaceable on the axle due to a change in length of the axle.

42. The hub assembly according to claim 35, wherein the end body is an end cap for the axle.

43. The hub assembly according to claim 42, wherein the end cap has an undersize relative to the axle so that it is pushable or pressable onto the axle.

44. The hub assembly according to claim 35,
wherein the bearing section of the end body is arranged on an outside of the inner ring of the rolling bearing, and/or
wherein the bearing section of the end body corresponds to an end of the end body relative to the longitudinal direction.

45. The hub assembly according to claim 35, further comprising a gap between the bearing section of the end body and the inner ring of the rolling bearing.

46. The hub assembly according to claim 35, further comprising a gap between the bearing section of the hub body and the outer ring of the rolling bearing.

47. The hub assembly according to claim 35, wherein the compensating element abuts directly on the inner ring or on the outer ring of the rolling bearing.

48. The hub assembly according to claim 35, wherein the compensating element is arranged such that it absorbs or compensates for a change in a gap width between the bearing section of the end body and the inner ring, or between the bearing section of the hub body and the outer ring, respectively.

49. The hub assembly according to claim 48, wherein the change in the gap width is brought about by a change in a length of the axle.

50. The hub assembly according to claim 49, wherein a width of the gap is between 0.05 and 0.25 mm, inclusive.

51. The hub assembly according to claim 35,
wherein the compensating element has resilient properties and/or damping properties with respect to the longitudinal direction, and/or
wherein the compensating element is made of plastic, of a rubber material, of metal, or of a mixture or a composite of at least two of these, and/or
wherein the compensating element comprises a steel spring, a wave washer or a leaf spring.

52. The hub assembly according to claim 35, wherein a plurality of compensating elements are arranged along a circumference of the inner ring or the outer ring of the rolling bearing.

53. The hub assembly according to claim 35, wherein the compensating element is annular and arranged along a circumference of the inner ring or the outer ring of the rolling bearing.

54. The hub assembly according to claim 53,
wherein the compensating element is an O-ring, and/or
wherein the compensating element abuts annularly on the axle, and/or on the hub body, and/or
wherein a cross-section of the compensating element as seen perpendicularly to its circumference is round, oval or angular.
